(19) United States
(12) Patent Application Publication
(10) Pub. No.: US 2026/0168637 A1
(43) Pub. Date: Jun. 18, 2026

(54) LAMP FOR VEHICLE

(71) Applicant: HYUNDAI MOBIS CO., LTD., Seoul (KR)

(72) Inventors: Na Ram JUN, Yongin-si (KR); Tae Yang PARK, Yongin-si (KR); Hyun Soo LEE, Yongin-si (KR)

(73) Assignee: HYUNDAI MOBIS CO., LTD., Seoul (KR)

(21) Appl. No.: 19/289,358

(22) Filed: Aug. 4, 2025

(30) Foreign Application Priority Data
Dec. 12, 2024 (KR) 10-2024-0184911

(51) Int. Cl. F21S 41/275

(52) U.S. Cl. CPC F21S 41/275

(57) ABSTRACT

A lamp for a vehicle includes a light source and a micro-cylinder lens part disposed forward of the light source. The micro-cylinder lens part includes a plurality of micro-lenses disposed in a horizontal direction and physically connected to one another, and one or more holes are formed in the micro-cylinder lens part.

### CROSS-REFERENCE TO RELATED APPLICATION

This application claims priority to and the benefit of Korean Patent Application No. 10-2024-0184911 filed in the Korean Intellectual Property Office on Dec. 12, 2024, the entire contents of which are incorporated herein by reference.

### TECHNICAL FIELD

The present disclosure relates to a lamp for a vehicle.

### BACKGROUND

There is an increasing demand for lamps for vehicles with aesthetic appearances as the lamps for vehicles have a significant impact on aesthetic external appearances of the vehicles.

Meanwhile, a lamp for a vehicle generally includes a light source, such as an LED, configured to emit light, and an inner lens. In the related art, an aspherical lens is typically used as the inner lens. However, there is a problem in that a degree of freedom of the aspherical lens remarkably deteriorates in terms of a shape and design thereof. This problem degrades a degree of design freedom of the lamp for a vehicle.

In addition, recently, there has been an attempt to apply a micro-lens such as a micro-cylinder lens or a micro-lens array to a new type of lamp for a vehicle. However, there is a problem in that the lamp for a vehicle, to which the micro-lens is applied, is difficult to manufacture because it is difficult to manage a tolerance during an assembling process.

In particular, because a micro-lens applied to an optical system has a very small width of several millimeters, there is a problem in that glare occurs in case that light emitted from a light source enters another micro-lens positioned at a periphery of the micro-lens positioned forward of the light source without entering the micro-lens positioned forward of the light source. A case in which a separate light-blocking member is installed may be considered to remove the glare. However, in this case, a dark area occurs in the vicinity of a region in which the light-blocking member is installed, which causes a problem in that overall uniformity of a light-emitting surface of the lamp deteriorates.

### SUMMARY

The present disclosure has been made in an effort to improve uniformity of a light-emitting surface of a lamp while solving a problem of glare that may occur in the lamp for a vehicle to which a micro-lens is applied.

In order to achieve the above-mentioned object, one aspect of the present disclosure provides a lamp for a vehicle, the lamp including: a light source; and a micro-cylinder lens part disposed forward of the light source, in which the micro-cylinder lens part includes a plurality of micro-lenses disposed in a horizontal direction and physically connected to one another, and in which one or more holes are formed in the micro-cylinder lens part.

The hole may include a plurality of holes spaced apart from one another in a leftward/rightward direction.

The one or more holes may be disposed over the plurality of micro-lenses adjacent to one another.

The one or more holes may be disposed over two micro-lenses adjacent to each other.

The lamp may include: an inner lens part disposed between the light source and the micro-cylinder lens part, in which the inner lens part includes a plurality of unit lenses spaced apart from one another in the horizontal direction, and in which the one or more holes face a space between two unit lenses adjacent to each other.

The one or more holes may be spaced apart from the plurality of unit lenses in the inner lens part in a leftward/rightward direction W intersecting a forward/rearward direction A in which the inner lens part faces the micro-cylinder lens part.

The lamp may include: a blocking member disposed between two unit lenses adjacent to each other, in which the blocking member is disposed to face the one or more holes in a forward/rearward direction A in which the inner lens part faces the micro-cylinder lens part.

A width of the blocking member may correspond to a width of the one or more holes in a leftward/rightward direction W intersecting the forward/rearward direction A.

Each of plurality of unit lenses may optically correspond to one of the plurality of micro-lenses.

A front end of the blocking member may be positioned forward of a front end of the unit lens.

The one or more holes may be formed through the micro-cylinder lens part in an upward/downward direction H.

The one or more holes may be spaced apart from an upper surface region and a lower surface region of the micro-cylinder lens part in an upward/downward direction H.

The one or more holes may have a shape in which a width in a forward/rearward direction A is larger than a width in a leftward/rightward direction W.

According to the present disclosure, it is possible to improve the uniformity of the light-emitting surface of the lamp while solving a problem of glare that may occur in the lamp for a vehicle to which the micro-lens is applied.

### BRIEF DESCRIPTION OF THE DRAWINGS

FIG. 1 is a side view schematically illustrating main components of a lamp for a vehicle according to the present disclosure.

FIG. 2 is a top plan view of the lamp for a vehicle according to the present disclosure.

FIG. 3 is a view illustrating one example of a vertical cross-sectional structure of a micro-cylinder lens part provided in the lamp for a vehicle according to the present disclosure.

FIG. 4 is a view illustrating another example of the vertical cross-sectional structure of the micro-cylinder lens part provided in the lamp for a vehicle according to the present disclosure.

### DETAILED DESCRIPTION

Hereinafter, a lamp for a vehicle according to the present disclosure will be described with reference to the drawings.

### LAMP FOR VEHICLE

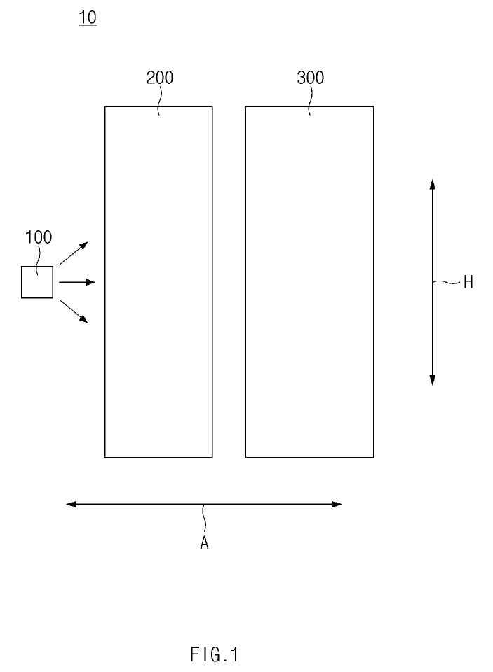

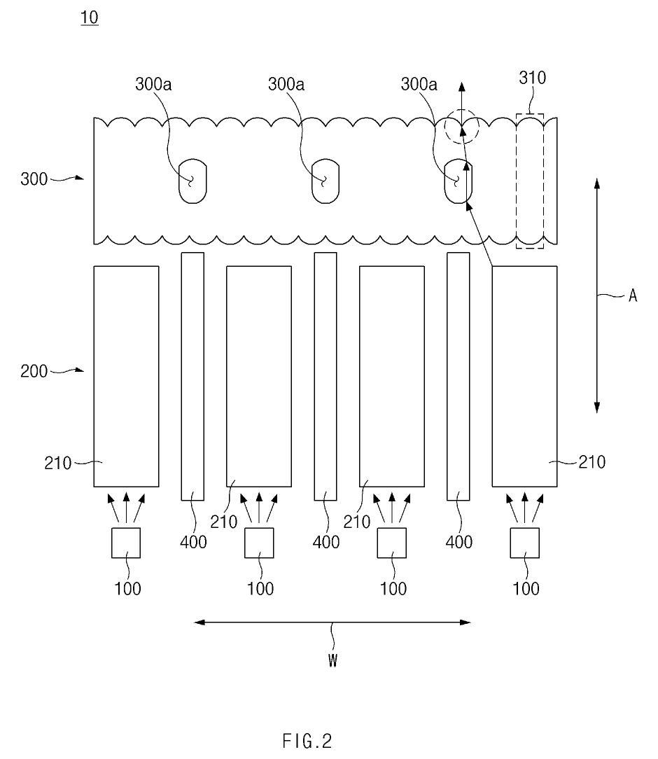

FIG. 1 is a side view schematically illustrating main components of a lamp for a vehicle according to the present disclosure, and FIG. 2 is a top plan view of the lamp for a vehicle according to the present disclosure.

The lamp for a vehicle (hereinafter, referred to as a 'lamp') according to the present disclosure may be configured to create a low-beam light distribution pattern or a high-beam light distribution pattern. However, the lamp according to the present disclosure may, of course, be configured to create other types of light distribution patterns.

As illustrated in FIGS. 1 and 2, a lamp 10 according to the present disclosure may include light sources 100 configured to emit light, and a micro-cylinder lens part 300 provided forward of the light sources 100. For example, the light source 100 may be an LED.

Meanwhile, according to the present disclosure, the micro-cylinder lens part 300 may include a plurality of micro-lenses 310 disposed in a horizontal direction and physically connected to one another. More specifically, the micro-cylinder lens part 300 may have a structure in which the plurality of micro-lenses 310 are arranged in the horizontal direction. A width of the micro-lens 310 in a leftward/rightward direction W may be several millimeters to several centimeters. Meanwhile, the micro-cylinder lens part disclosed in the present specification is configured such that the plurality of micro-lenses are connected and integrated. Therefore, it is noted that the micro-cylinder lens part is distinguished from a micro-lens array or the like in which separate incident lens arrays are joined to one another with shield members interposed therebetween.

Meanwhile, the lamp 10 according to the present disclosure may further include an inner lens part 200 provided between the light sources 100 and the micro-cylinder lens part 300. More specifically, the inner lens part 200 may be provided forward of the light source 100 and provided rearward of the micro-cylinder lens part 300.

In addition, according to the present disclosure, the inner lens part 200 may include a plurality of regions physically spaced apart from one another. More specifically, as illustrated in FIG. 2, the inner lens part 200 may include a plurality of unit lenses 210 provided to be spaced apart from one another in the horizontal direction (e.g., the leftward/rightward direction W). The plurality of unit lenses 210 in the inner lens part 200 may be provided to face one micro-cylinder lens part 300 in a forward/rearward direction A. Meanwhile, the light sources 100 may also be provided as a plurality of light sources 100 provided in the lamp 10 while corresponding to the number of unit lenses 210 in the inner lens part 200.

Meanwhile, according to the present disclosure, the plurality of unit lenses 210 may each optically correspond to the plurality of micro-lenses 310. In this case, it can be seen that one unit lens 210 optically corresponds to the plurality of micro-lenses 310 in case that light, which is emitted from the light source 100 and enters one unit lens 210, enters some of the plurality of micro-lenses 310 that constitute the micro-cylinder lens part 300.

With continued reference to FIG. 2, the lamp 10 according to the present disclosure may further include blocking members 400 each provided between the two unit lenses 210 adjacent to each other. More specifically, the blocking member 400 may be configured to block the propagation of light that is emitted from the light source 100 and reaches the blocking member 400. Therefore, according to the present disclosure, the blocking member 400 may be made of a material capable of blocking light in a visible wavelength region. More particularly, the blocking member 400 may have a color (e.g., black) that may absorb the light emitted from the light source 100. For example, as illustrated in FIG. 2, a front end of the blocking member 400 may be positioned forward of a front end of the unit lens 210.

According to the present disclosure, the blocking member 400 may be configured to prevent glare by preventing the light emitted from the light source 100 from reaching another unit lens 210 disposed at a periphery of the unit lens 210 positioned forward of the light source 100 without reaching the unit lens 210 positioned forward of the light source 100. However, in case that the light is blocked by the blocking member 400, almost no light may reach a region of the micro-cylinder lens part 300 that faces the blocking member 400 in the forward/rearward direction A. In this case, a dark area may be formed in the micro-cylinder lens part 300, which may cause a problem in that a light-emitting surface of the micro-cylinder lens part 300 is not uniform. Therefore, the lamp according to the present disclosure may further include a feature for preventing the non-uniform light-emitting surface described above.

Therefore, in order to achieve the above-mentioned purpose, as illustrated in FIG. 2, according to the present disclosure, one or more holes 300a may be formed in the micro-cylinder lens part 300. More particularly, the holes 300a may be provided as a plurality of holes 300a spaced apart from one another in the leftward/rightward direction W. The blocking member 400 may be provided to face the hole 300a in the forward/rearward direction A that is the direction in which the inner lens part 200 faces the micro-cylinder lens part 300. The above-mentioned hole 300a may be provided to face a space between the two adjacent unit lenses 210 (i.e., a space in which the blocking member is interposed).

According to the present disclosure, the hole 300a is formed in a region of the micro-cylinder lens part 300 in which a dark area may be formed. Therefore, a part of the light emitted from the light source exits to the outside through the hole 300a, which may uniformize the entire light-emitting surface of the micro-cylinder lens part 300.

Meanwhile, the above-mentioned plurality of holes 300a may be formed over the plurality of micro-lenses 310 adjacent to one another. For example, as illustrated in FIG. 2, the hole 300a may be formed over the two adjacent micro-lenses 310. More particularly, the hole 300a may have a symmetric shape with respect to a boundary between the two adjacent micro-lenses 310.

Meanwhile, according to the present disclosure, the holes 300a formed in the micro-cylinder lens part 300 may be spaced apart from the plurality of unit lenses 210 in the inner lens part 200 in the leftward/rightward direction W intersecting the forward/rearward direction A that is the direction in which the inner lens part 200 faces the micro-cylinder lens part 300. It may be understood that the hole 300a is positioned within a width in the leftward/rightward direction W of the space between the two adjacent unit lenses 210. Meanwhile, for example, FIG. 2 illustrates that the hole 300a has a shape in which a width of the hole 300a in the forward/rearward direction A is larger than a width of the hole 300a in the leftward/rightward direction W.

A width of the blocking member 400 in the leftward/rightward direction W intersecting the forward/rearward direction A may correspond to the width of the hole 300a.

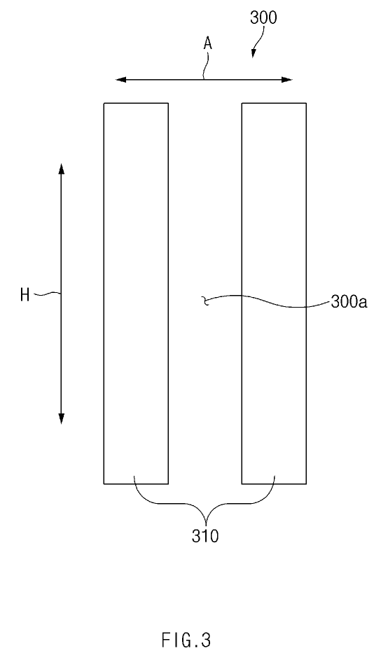

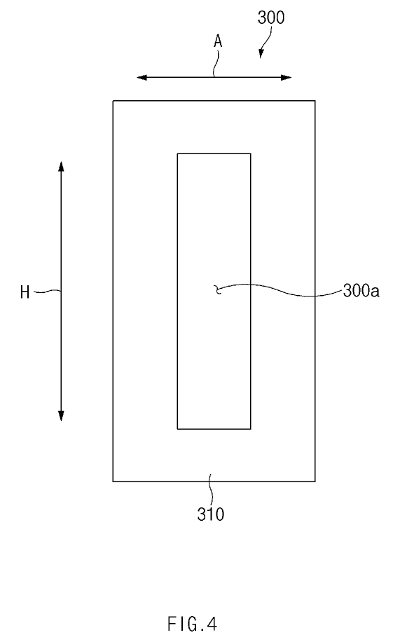

FIG. 3 is a view illustrating one example of a vertical cross-sectional structure of the micro-cylinder lens part provided in the lamp for a vehicle according to the present disclosure, and FIG. 4 is a view illustrating another example of the vertical cross-sectional structure of the micro-cylinder lens part provided in the lamp for a vehicle according to the present disclosure.

As illustrated in FIG. 3, the hole 300a according to the example of the present disclosure may be formed through the micro-cylinder lens part 300 in an upward/downward direction H. However, as illustrated in FIG. 4, the hole 300a according to another example of the present disclosure may be formed to be spaced apart from an upper surface region and a lower surface region of the micro-cylinder lens part 300 in the upward/downward direction H.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A lamp for a vehicle, the lamp comprising:
a light source; and
a micro-cylinder lens part disposed forward of the light source,
wherein the micro-cylinder lens part comprises a plurality of micro-lenses disposed in a horizontal direction and physically connected to one another, and
wherein one or more holes are disposed in the micro-cylinder lens part.

2. The lamp of claim 1, wherein the one or more holes include a plurality of holes spaced apart from one another in a leftward/rightward direction.

3. The lamp of claim 1, wherein the one or more holes are formed over the plurality of micro-lenses adjacent to one another.

4. The lamp of claim 1, wherein the one or more holes are formed over two micro-lenses adjacent to each other.

5. The lamp of claim 1, further comprising:
an inner lens part disposed between the light source and the micro-cylinder lens part,
wherein the inner lens part comprises a plurality of unit lenses spaced apart from one another in the horizontal direction, and
wherein the one or more holes face a space between two unit lenses adjacent to each other.

6. The lamp of claim 5, wherein the one or more holes are spaced apart from the plurality of unit lenses in the inner lens part in a leftward/rightward direction W intersecting a forward/rearward direction A in which the inner lens part faces the micro-cylinder lens part.

7. The lamp of claim 5, further comprising:
a blocking member provided between two unit lenses adjacent to each other,
wherein the blocking member is disposed to face the one or more holes in a forward/rearward direction A in which the inner lens part faces the micro-cylinder lens part.

8. The lamp of claim 7, wherein a width of the blocking member corresponds to a width of the one or more holes in a leftward/rightward direction W intersecting the forward/rearward direction A.

9. The lamp of claim 5, wherein each of the plurality of unit lenses optically corresponds to one of the plurality of micro-lenses.

10. The lamp of claim 7, wherein a front end of the blocking member is positioned forward of a front end of the unit lens.

11. The lamp of claim 1, wherein the one or more holes are formed through the micro-cylinder lens part in an upward/downward direction H.

12. The lamp of claim 1, wherein the one or more holes are spaced apart from an upper surface region and a lower surface region of the micro-cylinder lens part in an upward/downward direction H.

13. The lamp of claim 1, wherein the one or more holes have a shape in which a width in a forward/rearward direction A is larger than a width in a leftward/rightward direction W.
